(19) United States
(12) Patent Application Publication
(10) Pub. No.: US 2014/0176721 A1
(43) Pub. Date: Jun. 26, 2014

(54) MOBILE COMMAND SYSTEM AND MOBILE TERMINAL THEREOF

(71) Applicant: HON HAI PRECISION INDUSTRY CO., LTD., New Taipei (TW)

(72) Inventors: SHIH-CHENG WANG, New Taipei (TW); YI-WEN CAI, New Taipei (TW)

(73) Assignee: HON HAI PRECISION INDUSTRY CO., LTD., New Taipei (TW)

(21) Appl. No.: 14/025,832

(22) Filed: Sep. 13, 2013

(30) Foreign Application Priority Data
Dec. 26, 2012 (TW) 101149956

(51) Int. Cl. H04N 7/18

(52) U.S. Cl. CPC H04N 7/181
USPC 348/158

(57) ABSTRACT

A mobile terminal includes a wireless communicating module communicating with a monitoring central server storing video images of surrounding area of a plurality of monitoring terminals and identification information identifying the monitoring terminals through a wireless network, a request module generating a request instruction of monitoring one of the monitoring terminals and transmit the monitoring request instruction to the monitoring central server, a first display area, a second display area including a number of display areas, a display module receiving configured to display the video images, an identifying module configured to identify the video images displayed on the first display area and selected by the user, and a plurality of projection modules configured to project the video images transmitted from the first display area to one of the display areas in response to an operation on a projection medium. A mobile command system is also provided.

### BACKGROUND

1. Technical Field

The present disclosure relates to a mobile command system and a mobile terminal thereof.

2. Description of Related Art

Monitoring systems include a number of monitoring terminals and a monitoring central server. Each monitoring terminal captures video images surrounding area of the monitoring terminal and transmits the video images to the monitoring central server. A human monitor, monitors the surrounding areas of the monitoring terminals through the monitoring central server. The monitoring central generally is positioned in a constant place. Thus, the monitor also is in a constant space.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a mobile command system, according to an embodiment.

FIG. 2 is a schematic view of a mobile terminal employed in the mobile command system of FIG. 1.

### DETAILED DESCRIPTION

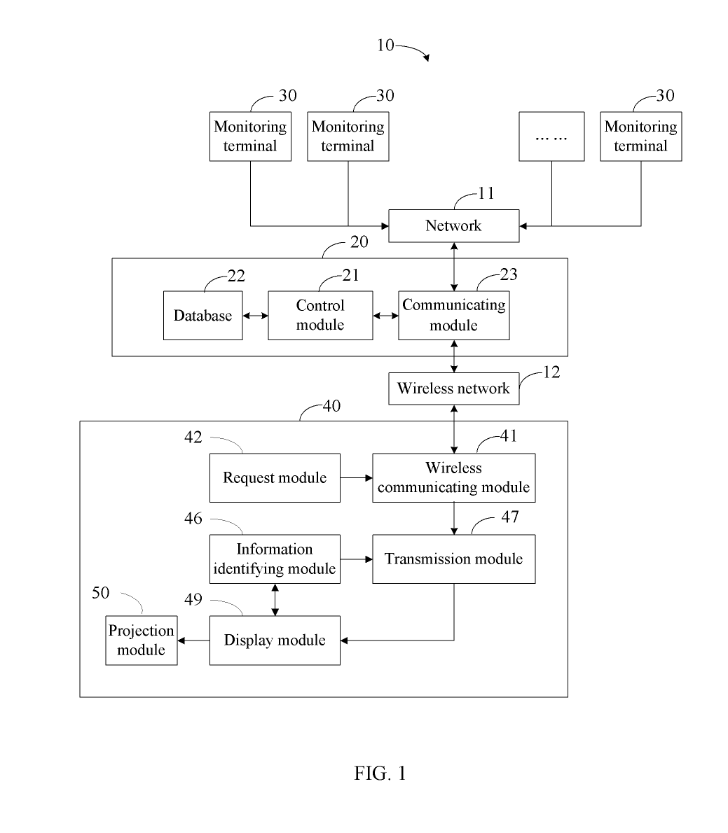

FIG. 1 shows an exemplary embodiment of a mobile command system 10. The mobile command system 10 includes a monitoring central server 20, a number of monitoring terminal 30 and a mobile terminal 40. The monitoring terminals 30 all communicate with the monitoring central server 20 through a network 11. Each monitoring terminal 30 is configured to obtain a video image of surrounding area of the monitoring terminal 30 and transmit the video image to the monitoring central server 20 in real time. The monitoring terminal 30 further transmits identification information identifying the monitoring terminal 30 to the monitoring central server 20. The identification information includes an internet address of the monitoring terminal 30.

The monitoring central server 20 includes a control module 21, a database 22 and a communicating module 23. The communicating module 23 is configured to communicate with the monitoring terminals 30 through the network 11. The control module 21 is configured to receive and store the video image and the identification information transmitted from the monitoring terminal 30 to the database 22.

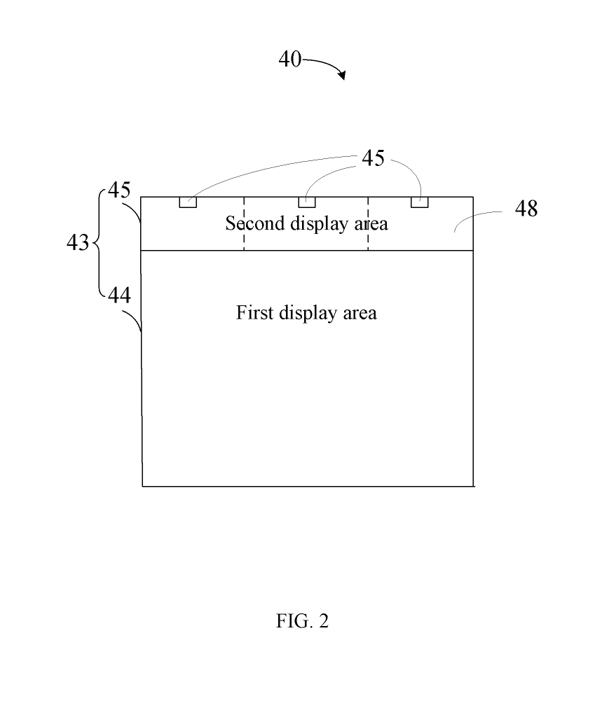

FIG. 2 shows that the mobile terminal 40 includes a wireless communicating module 41, a request module 42, a display 43 including a first display area 44 and a second display area 45, a display module 49, an identifying module 46, a transmission module 47 and a number of projection modules fixed to a housing of the mobile terminal 40. The second display area 45 includes a number of display areas 48 corresponding to the respective projection modules 50. The wireless communicating module 43 is configured to communicate with the monitoring central server 20 through a wireless network 12. The request module 42 is configured to generate a request instruction of monitoring at least one of the monitoring terminals 30 in respond to a first operation and transmits the monitoring request instruction to the monitoring central server 20 through the wireless communicating module 41. The request instruction includes the identification information of the at least one of the monitoring terminals 30.

The control module 21 is further configured to determine the identification information according to the request instruction from the mobile terminal 40 and obtain the video image corresponding to the identification information, and transmits the video image to the mobile terminal 40.

In an alternative embodiment, the database 22 further stores a map showing a distribution of the monitoring terminals 30 and original images of surrounding areas of each of the monitoring terminals 30. The map indicates positions of the monitoring terminals 30 and walkways surrounding the respective monitoring terminals 30. Each original image indicates fire equipment and exits surrounding the corresponding monitoring terminal 30. The control module 21 also obtains the map and/or the original image of the at least one of the monitoring terminals 30 associated with the identification information, and transmits the obtained map and/or the original image to the mobile terminal 40. In following statement, the video image, the map and the original image are all called “monitored information”.

The transmission module 47 is configured to receive the monitored information transmitted from the monitoring central server 20. The mobile terminal 40 installs a monitoring operation system. The monitoring operation system provides an output interface to display the monitored information for the user. The user can provide rescue measures according to the monitored information. The display module 49 is configured to display the monitored information on the first display area 44 and determine the monitored information selected by the user according to a second operation through the monitoring operation system. The identifying module 46 is configured to identify the monitored information displayed on the first display area 44 and selected by the user. The transmission module 47 is further configured to transmit the selected monitored information from the first display area 44 to one of the display areas 48 in response to a third operation. In the exemplary embodiment, the display 43 is a touch screen, the user touches the corresponding monitored information twice to select the monitored information, and the third operation includes a slide touch from the first display area 44 to one of the display area 48.

The projection modules 50 are configured to project the monitored information displayed on the corresponding display areas 48 on a projection panel, such as, a wall. In the exemplary embodiment, one of the projection module projects the monitored information in horizontal projection, and another one of the projection module projects the monitored information in vertical projection. The “horizontal projection” means that the monitored information is reversed 90 degrees to project.

The display module 49 is further configured to update the first display area 44 with the monitored information displayed on one of the display areas 48 according to a forth operation. The forth operation includes a slide touch from one of the display areas 48 to the first display area 44.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A mobile command system comprising:
a plurality of monitoring terminals, each monitoring terminal configured to obtain a video image of surrounding area of the monitoring terminal and transmit the video image and identification information identifying the monitoring terminal;
a monitoring central server communicating with the monitoring terminals, the monitoring central server comprising
a database; and
a control module configured to store the video image and the identification information transmitted from the monitoring terminal in the database;
a mobile terminal with a monitoring operation system installed therein, the monitoring operation system configured to provide an output interface, the mobile terminal comprising
a wireless communicating module configured to communicate with the monitoring central server through a wireless network; and
a request module configured to generate a request instruction of monitoring at least one of the monitoring terminals in response a user's first operation and transmit the monitoring request instruction to the monitoring central server through the wireless communicating module, the request instruction comprising the identification information of the at least one of the monitoring terminals; the control module further configured to determine the identification information according to the request instruction from the mobile terminal and obtain the video images associated with the identification information, and transmit the video images to the at least one of the mobile terminals; the mobile terminal further comprising
a transmission module configured to receive the video images transmitted from the monitoring central server;
a display comprising a first display area and a second display area, the second display area comprising a plurality of display areas;
a display module configured to display the video images on the first display area and determine a video image selected by the user according to the user's second operation through the monitoring operation system;
an identifying module configured to identify the video image displayed on the first display area and selected by the user; the transmission module further configured to transmit the selected video image from the first display area to one of the display areas in response to a user's third operation; and
a plurality of projection modules corresponding to the respective display areas, each projection module configured to project the video image displayed on the corresponding display area on a projection panel.

2. The mobile command system as described in claim 1, wherein the database further stores a map showing a distribution of the monitoring terminals and original images of surrounding areas of each of the monitoring terminals, the control module is configured to obtain at least one of the map, and the original image of the at least one of the monitoring terminals associated with the identification information, and transmits the obtained at least one of the map and the original image to the at least one of the mobile terminals.

3. The mobile command system as described in claim 2, wherein the map indicates positions of the monitoring terminals and walkways surrounding the respective monitoring terminals.

4. The mobile command system as described in claim 2, wherein each original image indicates fire equipments and exits surrounding the corresponding monitoring terminal.

5. The mobile command system as described in claim 1, wherein the display is a touch screen configured to allow the user to touch the corresponding video image twice to select the monitored information, and the user's third operation includes a slide touch from the first display area to the one of the display area.

6. The mobile command system as described in claim 1, wherein the identification information includes an internet address of the monitoring terminal.

7. A mobile terminal with a monitoring operation system installed therein, the monitoring operation system configured to provide an interface to display information, the mobile terminal comprising
a wireless communicating module configured to communicate with a monitoring central server storing video images of surrounding area of a plurality of monitoring terminals and identification information identifying the monitoring terminals through a wireless network; and
a request module configured to generate a request instruction of monitoring at least one of the monitoring terminals in response a user's first operation and transmit the monitoring request instruction to the monitoring central server through the wireless communicating module;
a transmission module configured to receive the video images corresponding to the at least one of the monitoring terminals transmitted from the monitoring central server;
a display comprising a first display area and a second display area, the second display area comprising a plurality of display areas;
a display module configured to display video images on the first display area and determine video images selected by a user according to the user's second operation through the monitoring operation system;
an identifying module configured to identify the video images displayed on the first display area and selected by the user;
the transmission module further configured to transmit the selected video image from the first display area to one of the display areas in response to a user's third operation; and
a plurality of projection modules corresponding to the respective display areas, each projection module configured to project the video image displayed on the corresponding display area on a projection panel.

8. The mobile terminal as described in claim 7, wherein the monitoring central server further stores a map showing a distribution of the monitoring terminals and original images of each of surrounding areas of the monitoring terminals, and the transmission module further receives at least one of the map and the original image of the at least one of the monitoring terminals transmitted form the monitoring central server.

9. The mobile terminal as described in claim 8, wherein the map indicates positions of the monitoring terminals and walkways surrounding the respective monitoring terminals.

10. The mobile terminal as described in claim 8, wherein each original image indicates fire equipments and exits surrounding the corresponding monitoring terminal.

11. The mobile terminal as described in claim 7, wherein the display is a touch screen configured to allow the user to touch the corresponding video image twice to select the monitored information, and the user's third operation includes a slide touch from the first display area to the one of the display area.

12. The mobile terminal as described in claim 7, wherein the identification information includes an internet address of the monitoring terminal.

13. The mobile terminal as described in claim 7, wherein the display module is further configured to display the video image displayed on one of the display areas on the first display area according to a user's forth operation.

14. The mobile terminal as described in claim 13, wherein the display is a touch screen, the forth operation comprises a slide touch from the one of the display areas to the first display area.
